(19) United States
(12) Patent Application Publication
(10) Pub. No.: US 2019/0063995 A1
(43) Pub. Date: Feb. 28, 2019

(54) COLOR PARAMETER MEASUREMENT DEVICE AND COLOR PARAMETER MEASUREMENT METHOD

(71) Applicants: BOE TECHNOLOGY GROUP CO., LTD., Beijing (CN); BOE (HEBEI) MOBILE DISPLAY TECHNOLOGY CO., LTD., Hebei (CN)

(72) Inventors: Yongjun LIAO, Beijing (CN); Yingying LIU, Beijing (CN); Zhen WU, Beijing (CN); Xing LI, Beijing (CN); Huijun MA, Beijing (CN)

(73) Assignees: BOE TECHNOLOGY GROUP CO., LTD., Beijing (CN); BOE (HEBEI) MOBILE DISPLAY TECHNOLOGY CO., LTD., Hebei (CN)

(21) Appl. No.: 15/983,137

(22) Filed: May 18, 2018

(30) Foreign Application Priority Data
Aug. 29, 2017 (CN) 201710756440.3

(51) Int. Cl. G01J 3/51; G02B 27/10; G01J 3/50; G01J 3/02

(52) U.S. Cl. CPC G01J 3/513; G01J 3/0229; G01J 3/506; G02B 27/1013

(57) ABSTRACT

A color parameter measurement device and a color parameter measurement method are provided. A display light beam from a to-be-tested display panel is split by a beam-splitting assembly into at least testing light beams corresponding to a light-beam-in-first-color filter, a light-beam-in-second-color filter and a light-beam-in-third-color filter respectively. Next, a light-beam-in-first-color component, a light-beam-in-second-color component and a light-beam-in-third-color component of the corresponding testing light beams are transmitted to corresponding receivers through the corresponding filters. Then, the light-beam-in-first-color component, the light-beam-in-second-color component and the light-beam-in-third-color component are converted into electric signals by the corresponding receivers, and then outputted to a processor for color parameter analysis.

### CROSS-REFERENCE TO RELATED APPLICATION

This application claims priority to Chinese Patent Application No. 201710756440.3 filed on Aug. 29, 2017, which is incorporated herein by reference in its entirety.

### TECHNICAL FIELD

The present disclosure relates to the detection of an optical element, in particular to a color parameter measurement device and a color parameter measurement method.

### BACKGROUND

Currently, color analysis on a display panel is mainly performed using a beam-splitting spectrometer, i.e., wavelength components of light beams from the display panel in a chromaticity spectrum are measured and treated so as to acquire a color parameter of the display panel. It takes a very long time period, e.g., more than one second, for this measurement. In the case that the beam-splitting spectrometer is adopted during the production of the display panel, the product line efficiency may be significantly adversely affected, and a measurement time period may increase.

### SUMMARY

In one aspect, the present disclosure provides in some embodiments a color parameter measurement device, including a beam-splitting assembly, a light-beam-in-first-color filter, a light-beam-in-second-color filter, a light-beam-in-third-color filter, a light-beam-in-first-color receiver, a light-beam-in-second-color receiver, a light-beam-in-third-color receiver, and a processor. The beam-splitting assembly is configured to split a display light beam from a to-be-tested display panel into at least a first testing light beam, a second testing light beam and a third testing light beam. The light-beam-in-first-color filter is configured to allow a light-beam-in-first-color component of the first testing light beam to be transmitted to the light-beam-in-first-color receiver. The light-beam-in-first-color receiver is configured to convert the light-beam-in-first-color component into a first electric signal and output the first electric signal. The light-beam-in-second-color filter is configured to allow a light-beam-in-second-color component of the second testing light beam to be transmitted to the light-beam-in-second-color receiver. The light-beam-in-second-color receiver is configured to convert the light-beam-in-second-color component into a second electric signal and output the second electric signal. The light-beam-in-third-color filter is configured to allow a light-beam-in-third-color component of the third testing light beam to be transmitted to the light-beam-in-third-color receiver. The light-beam-in-third-color receiver is configured to convert the light-beam-in-third-color component into a third electric signal and output the third electric signal. The processor is configured to determine a color parameter of the light-beam-in-first-color component in the display light beam in accordance with the first electric signal from the light-beam-in-first-color receiver, determine a color parameter of the light-beam-in-second-color component in the display light beam in accordance with the second electric signal from the light-beam-in-second-color receiver, and determine a color parameter of the light-beam-in-third-color component in the display light beam in accordance with the third electric signal from the light-beam-in-third-color receiver.

In a possible embodiment of the present disclosure, the color parameter measurement device further includes a light-beam-in-first-color convergent lens arranged on an optical path between the light-beam-in-first-color receiver and the light-beam-in-first-color filter, a light-beam-in-second-color convergent lens arranged on an optical path between the light-beam-in-second-color receiver and the light-beam-in-second-color filter, and a light-beam-in-third-color convergent lens arranged on an optical path between the light-beam-in-third-color receiver and the light-beam-in-third-color filter.

In a possible embodiment of the present disclosure, the beam-splitting assembly is an optical fiber assembly.

In a possible embodiment of the present disclosure, the color parameter measurement device further includes a first collimating lens arranged on an optical path between the optical fiber assembly and the light-beam-in-first-color filter, a second collimating lens arranged on an optical path between the optical fiber assembly and the light-beam-in-second-color filter, and a third collimating lens arranged on an optical path between the optical fiber assembly and the light-beam-in-third-color filter.

In a possible embodiment of the present disclosure, the color parameter measurement device further includes a first doublet and a second doublet arranged on an optical path between the optical fiber assembly and the to-be-tested display panel and opposite to each other. A convex surface of the first doublet is arranged to face the to-be-tested display panel, and a convex surface of the second doublet is arranged to face the optical fiber assembly.

In a possible embodiment of the present disclosure, the beam-splitting assembly includes a beam splitter and a reflector, or a grating and the reflector, or a prism and the reflector.

In a possible embodiment of the present disclosure, the color parameter measurement device further includes a collimating lens assembly arranged on an optical path between the beam-splitting assembly and the to-be-tested display panel.

In a possible embodiment of the present disclosure, the color parameter measurement device further includes a third doublet and a fourth doublet arranged on an optical path between the collimating lens assembly and the to-be-tested display panel and opposite to each other. A convex surface of the third doublet is arranged to face the to-be-tested display panel, and a convex surface of the fourth doublet is arranged to face the collimating lens assembly.

In a possible embodiment of the present disclosure, the color parameter measurement device further includes a dark state receiver arranged in a plane same as the light-beam-in-first-color receiver, the light-beam-in-second-color receiver and the light-beam-in-third-color receiver, and configured to convert an ambient light beam into an ambient light electric signal and output the ambient light electric signal. The processor is further configured to determine a noise parameter of the ambient light beam in accordance with the ambient light electric signal from the dark state receiver.

In a possible embodiment of the present disclosure, the color parameter measurement device further includes a light-beam-in-fourth-color receiver. The beam-splitting assembly is further configured to split the display light beam from the to-be-tested display panel into a fourth testing light beam. The light-beam-in-fourth-color receiver is configured to convert an optical signal of the fourth testing light beam into a fourth electric signal and output the electric signal. The processor is further configured to determine a brightness value of the display light beam in accordance with the fourth electric signal from the light-beam-in-fourth-color receiver.

In a possible embodiment of the present disclosure, the color parameter measurement device further includes a glass plate arranged on an optical path between the light-beam-in-fourth-color receiver and the beam-splitting assembly.

In a possible embodiment of the present disclosure, the color parameter measurement device further includes a light-beam-in-fourth-color convergent lens arranged on an optical path between the light-beam-in-fourth-color receiver and the glass plate.

In a possible embodiment of the present disclosure, the beam-splitting assembly is an optical fiber assembly, and the color parameter measurement device further includes a fourth collimating lens arranged on an optical path between the optical fiber assembly and the glass plate.

In a possible embodiment of the present disclosure, wherein a first color, a second color and a third color are red, green and blue respectively.

In a possible embodiment of the present disclosure, a fourth color is white.

In another aspect, the present disclosure provides in some embodiments a color parameter measurement method using the above-mentioned color parameter measurement device, including steps of: splitting, by a beam-splitting assembly, a display light beam from a to-be-tested display panel into at least a first testing light beam, a second testing light beam and a third testing light beam; allowing, by a light-beam-in-first-color filter, a light-beam-in-first-color component of the first testing light beam to be transmitted to a light-beam-in-first-color receiver, and converting, by the light-beam-in-first-color receiver, the light-beam-in-first-color component into a first electric signal and outputting the first electric signal; allowing, by a light-beam-in-second-color filter, a light-beam-in-second-color component of the second testing light beam to be transmitted to a light-beam-in-second-color receiver, and converting, by the light-beam-in-second-color receiver, the light-beam-in-second-color component into a second electric signal and outputting the second electric signal; allowing, by a light-beam-in-third-color filter, a light-beam-in-third-color component of the third testing light beam to be transmitted to a light-beam-in-third-color receiver, and converting, by the light-beam-in-third-color receiver, the light-beam-in-third-color component into a third electric signal and outputting the third electric signal; and determining, by a processor, a color parameter of the light-beam-in-first-color component in the display light beam in accordance with the first electric signal from the light-beam-in-first-color receiver, determining a color parameter of the light-beam-in-second-color component in the display light beam in accordance with the second electric signal from the light-beam-in-second-color receiver, and determining a color parameter of the light-beam-in-third-color component in the display light beam in accordance with the third electric signal from the light-beam-in-third-color receiver.

In a possible embodiment of the present disclosure, the color parameter measurement method further includes: splitting, by the beam-splitting assembly, the display light beam from the to-be-tested display panel into a fourth testing light beam; converting, by a light-beam-in-fourth-color receiver, an optical signal of the fourth testing light beam into a fourth electric signal and outputting the electric signal; and determining, by the processor, a brightness value of the display light beam in accordance with the fourth electric signal from the light-beam-in-fourth-color receiver.

In a possible embodiment of the present disclosure, a first color, a second color, a third color and a fourth color are red (R), green (G), blue (B) and white (W) respectively.

### BRIEF DESCRIPTION OF THE DRAWINGS

FIG. 1 is a schematic view showing a color parameter measurement device according to one embodiment of the present disclosure;

FIG. 2 is another schematic view showing the color parameter measurement device according to one embodiment of the present disclosure;

FIG. 3 is a schematic view showing an optical fiber assembly of the color parameter measurement device according to one embodiment of the present disclosure;

FIG. 4 is a flow chart of a color parameter measurement method according to one embodiment of the present disclosure; and

FIG. 5 is another flow chart of the color parameter measurement method according to one embodiment of the present disclosure.

### DETAILED DESCRIPTION

The present disclosure will be described hereinafter in conjunction with the drawings and embodiments. Shapes and sizes of the members in the drawings are for illustrative purposes only, but shall not be used to reflect any actual scale.

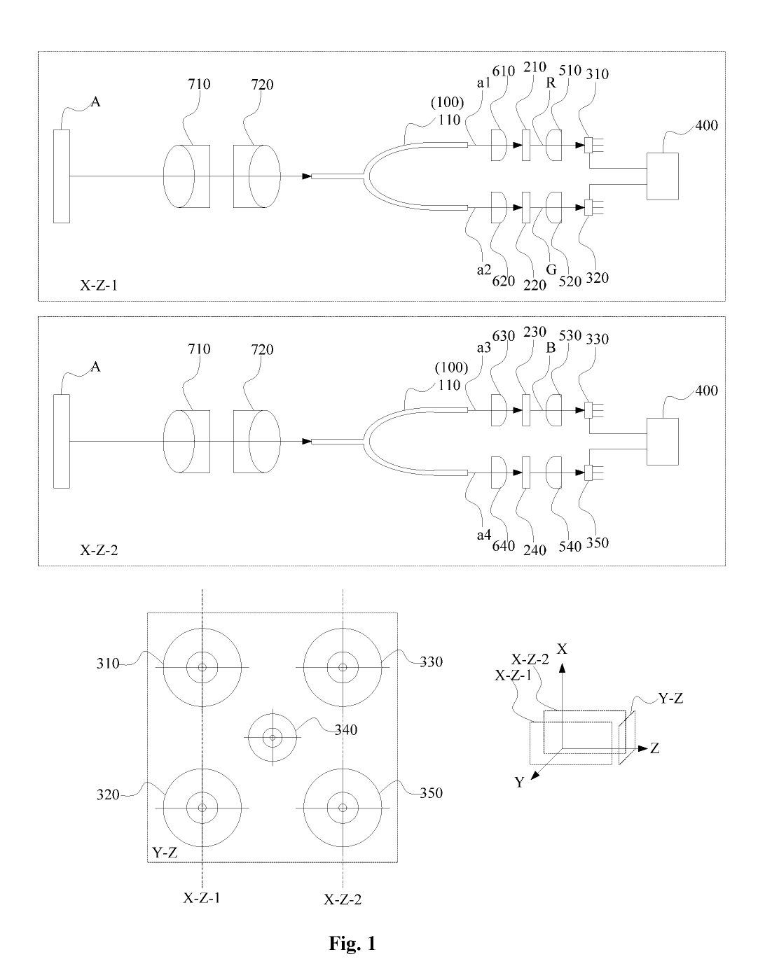

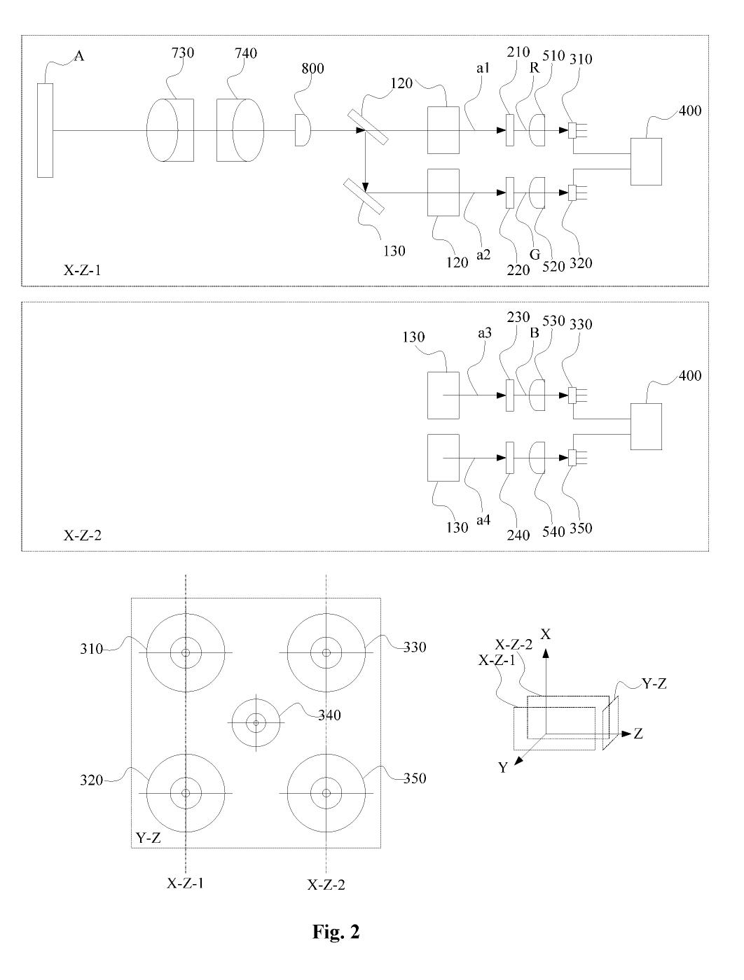

The present disclosure provides in some embodiments a color parameter measurement device which, as shown in FIGS. 1 and 2, includes: a beam-splitting assembly 100, a light-beam-in-first-color filter 210, a light-beam-in-second-color filter 220, a light-beam-in-third-color filter 230, a light-beam-in-first-color receiver 310, a light-beam-in-second-color receiver 320, a light-beam-in-third-color receiver 330, and a processor 400.

The beam-splitting assembly 100 is configured to split a display light beam from a to-be-tested display panel A into at least a first testing light beam a1, a second testing light beam a2 and a third testing light beam a3.

The light-beam-in-first-color filter 210 is configured to allow a light-beam-in-first-color component R of the first testing light beam a1 to be transmitted to the light-beam-in-first-color receiver 310. The light-beam-in-first-color receiver 310 is configured to convert the light-beam-in-first-color component R into an electric signal and output the electric signal.

The light-beam-in-second-color filter 220 is configured to allow a light-beam-in-second-color component G of the second testing light beam a2 to be transmitted to the light-beam-in-second-color receiver 320. The light-beam-in-second-color receiver 320 is configured to convert the light-beam-in-second-color component G into an electric signal and output the electric signal.

The light-beam-in-third-color filter 230 is configured to allow a light-beam-in-third-color component B of the third testing light beam a3 to be transmitted to the light-beam-in-third-color receiver 330. The light-beam-in-third-color receiver 330 is configured to convert the light-beam-in-third-color component B into an electric signal and output the electric signal.

The processor 400 is configured to determine a color parameter of the light-beam-in-first-color component R in the display light beam in accordance with the electric signal from the light-beam-in-first-color receiver 310, determine a color parameter of the light-beam-in-second-color component G in the display light beam in accordance with the electric signal from the light-beam-in-second-color receiver 320, and determine a color parameter of the light-beam-in-third-color component B in the display light beam in accordance with the electric signal from the light-beam-in-third-color receiver 330.

For example, a first color is red R, a second color is green G and a third color is blue B.

The color parameter may include luminance Lv, color coordinates x and y. The relationship between R, G, B and Lv, x, y may be represented by the following equations: X=2.7689R+1.7517G+1.1302B;

Y=1.0000R+5.5907G+0.0601B

Z=0R+0.0565G+5.5943B

x=X/(X+Y+Z)

y=Y/(X+Y+Z)

Lv=Y

Wherein the R, G, B in the equations are proportional to the R, G, B components received by the processor 400.

According to the color parameter measurement device in the embodiments of the present disclosure, the display light beam from the to-be-tested display panel A is split by the beam-splitting assembly 100 into at least the testing light beams a1, a2 and a3 corresponding to the light-beam-in-first-color filter 210, the light-beam-in-second-color filter 220 and the light-beam-in-third-color filter 230 respectively. Next, the light-beam-in-first-color component R, the light-beam-in-second-color component G and the light-beam-in-third-color component B of the corresponding testing light beams are transmitted to the corresponding receivers 310, 320 and 330 through the corresponding filters. Then, the light-beam-in-first-color component R, the light-beam-in-second-color component G and the light-beam-in-third-color component B are converted into electric signals by the corresponding receivers (light radiation energy is converted into current intensity energy by using an optical-electrical converter), and then outputted to the processor 400 for color parameter analysis, so as to rapidly calculate color characteristics of the to-be-tested display panel. As compared with the color parameter measurement using a beam-splitting spectrometer in the related art, through the color parameter measurement device in the embodiments of the present disclosure, it is able to shorten a measurement time period (e.g., reduce the measurement time period from 1-2 S to less than 50 ms), thereby to improve the production line efficiency.

It should be appreciated that, in order to perform the color parameter analysis accurately, the light-beam-in-first-color filter 210, the light-beam-in-second-color filter 220 and the light-beam-in-third-color filter 230 conform to an ICE1931 standard.

In addition, in order to improve utilization of the testing light beams a1, a2 and a3, the beam-splitting assembly 100 may be further configured to split the display light beam into the testing light beams a1, a2 and a3 with different wavelengths corresponding to colors of the filters respectively.

During the implementation, in order to improve the photoelectric conversion efficiency of the receiver corresponding to each standard monochromatic light beam as well as computational efficiency of the color parameter, as shown in FIGS. 1 and 2, the color parameter measurement device may further include a light-beam-in-first-color convergent lens 510 arranged on an optical path between the light-beam-in-first-color receiver 310 and the light-beam-in-first-color filter 210, a light-beam-in-second-color convergent lens 520 arranged on an optical path between the light-beam-in-second-color receiver 320 and the light-beam-in-second-color filter 220, and a light-beam-in-third-color convergent lens 530 arranged on an optical path between the light-beam-in-third-color receiver 330 and the light-beam-in-third-color filter 230.

To be specific, the light-beam-in-first-color convergent lens 510 may converge light energy of the light-beam-in-first-color component R from the light-beam-in-first-color filter 210 at a point on the light-beam-in-first-color receiver 310, so as to enable the light-beam-in-first-color receiver 310 to receive the light beam in an energy concentration manner, thereby to improve a response speed of the light-beam-in-first-color receiver 310. The light-beam-in-second-color convergent lens 520 may converge light energy of the light-beam-in-second-color component G from the light-beam-in-second-color filter 220 at a point on the light-beam-in-second-color receiver 320, so as to enable the light-beam-in-second-color receiver 320 to receive the light beam in an energy concentration manner, thereby to improve a response speed of the light-beam-in-second-color receiver 320. The light-beam-in-third-color convergent lens 530 may converge light energy of the light-beam-in-third-color component B from the light-beam-in-third-color filter 230 at a point on the light-beam-in-third-color receiver 330, so as to enable the light-beam-in-third-color receiver 330 to receive the light beam in an energy concentration manner, thereby to improve a response speed of the light-beam-in-third-color receiver 330. In addition, usually a convex of each convergent lens is arranged in such a manner as to face away from an object, i.e., face the corresponding filer.

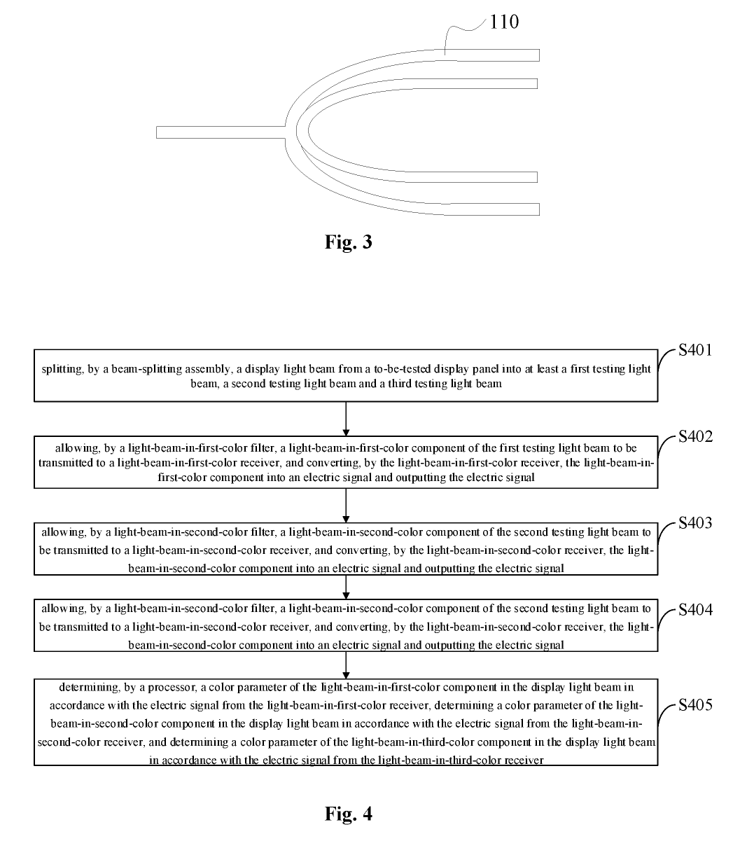

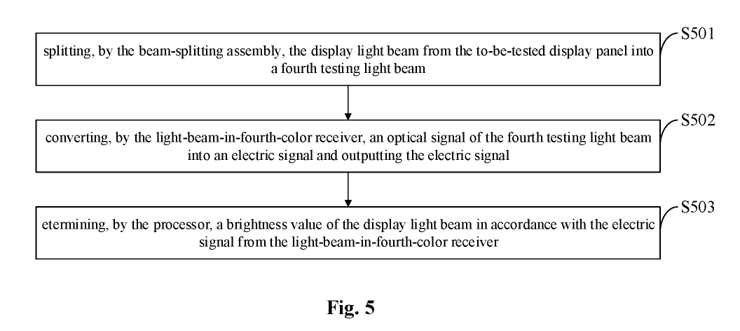

During the implementation, as shown in FIG. 1, the beam-splitting assembly 100 may be an optical fiber assembly 110, and FIG. 3 shows the structure of the optical fiber assembly 110.

During the implementation, it is able for the optical fiber assembly 110 to easily split an incident light beam, i.e., the display light beam, into the testing light beams in a desired amount according to the practical need. However, it is impossible for the optical fiber assembly 110 to control an emergent direction of the light beam accurately. Based on this, as shown in FIG. 1, the color parameter measurement device may further include a first collimating lens 610 arranged on an optical path between the optical fiber assembly 110 and the light-beam-in-first-color filter 210, a second collimating lens 620 arranged on an optical path between the optical fiber assembly 110 and the light-beam-in-second-color filter 220, and a third collimating lens 630 arranged on an optical path between the optical fiber assembly 110 and the light-beam-in-third-color filter 230.

To be specific, the first collimating lens 610 may collimate the first testing light beam a1 from the optical fiber assembly 110 toward the light-beam-in-first-color filter 210, so as to reduce any interference light beam on the optical path. The second collimating lens 620 may collimate the second testing light beam a2 from the optical fiber assembly 110 toward the light-beam-in-second-color filter 220, so as to reduce any interference light beam on the optical path. The third collimating lens 630 may collimate the third testing light beam a3 from the optical fiber assembly 110 toward the light-beam-in-third-color filter 230, so as to reduce any interference light beam on the optical path. Usually, a convex of each collimating lens is arranged in such a manner as to face the object, i.e., face the corresponding filter.

During the implementation, in order to reduce the chromatic aberration during the color parameter measurement and prevent the interference light beam entering the optical fiber assembly 110 from interfering with the subsequent optical path, as shown in FIG. 1, the color parameter measurement device may further include a first doublet 710 and a second doublet 720 arranged on an optical path between the optical fiber assembly 110 and the to-be-tested display panel A and opposite to each other. The first doublet 710 may be separated from the second doublet 720 by a certain distance. A convex surface of the first doublet 710 is arranged in such a manner as to face the to-be-tested display panel A, and a convex surface of the second doublet 720 is arranged in such a manner as to face the optical fiber assembly 110. To be specific, the first doublet 710 and the second doublet 720 are a positive lens having a low refractive index (i.e., a lens made of crown glass) and a negative lens having a high refractive index (i.e., a lens made of flint glass). Through optimization using a computer, it is able to adjust paraxial aberration of each doublet (e.g., spherical aberration, comatic aberration and chromatic aberration) in a better manner.

During the implementation, as shown in FIG. 2, the beam-splitting assembly 100 may include a beam splitter 120 and a reflector 130, or a grating and the reflector, or a prism and the reflector. In other words, a beam splitting function of the beam-splitting assembly 100 may be achieved through the beam splitter 120, the grating or the prism, and then the reflector may be used to change the optical path. In FIG. 2, the beam-splitting assembly 100 consists of three beam splitters 120 and three reflectors 130. The beam splitter 120 and the reflector 130 on the left are angled by 45° relative to the optical path, and the beam splitter 120 and the reflector 130 on the right are angled by 45° relative to the optical path and face a direction different from those on the left.

During the implementation, a direction of the incident light beam is strictly required by such optical element as the reflector 120. Based on this, as shown in FIG. 2, the color parameter measurement device may further include a collimating lens assembly 800 arranged on an optical path between the beam-splitting assembly 100 and the to-be-tested display panel A, so as to control the direction of the incident light beam toward a first beam splitter 120 of the beam-splitting assembly 100.

During the implementation, in order to reduce the chromatic aberration during the color parameter measurement and prevent the interference light beam entering the optical fiber assembly 110 from interfering with the subsequent optical path, as shown in FIG. 2, the color parameter measurement device may further include a third doublet 730 and a fourth doublet 740 arranged on an optical path between the collimating lens assembly 800 and the to-be-tested display panel A and opposite to each other. A convex surface of the third doublet 730 is arranged in such a manner as to face the to-be-tested display panel A, and a convex surface of the fourth doublet 740 is arranged in such a manner as to face the collimating lens assembly 800. To be specific, the third doublet 730 and the fourth doublet 740 are a positive lens having a low refractive index (i.e., a lens made of crown glass) and a negative lens having a high refractive index (i.e., a lens made of flint glass). Through optimization using a computer, it is able to adjust paraxial aberration of each doublet (e.g., spherical aberration, comatic aberration and chromatic aberration) in a better manner.

During the implementation, as shown in FIGS. 1 and 2, the color parameter measurement device may further include a dark state receiver 340 arranged in a plane same as the light-beam-in-first-color receiver, the light-beam-in-second-color receiver and the light-beam-in-third-color receiver, and configured to convert an ambient light beam into an electric signal and output the electric signal. The processor 400 is further configured to determine a noise parameter of the ambient light beam in accordance with the electric signal from the dark state receiver 340, so as to remove the effect of the noise parameter during calculating the color parameter and luminance. Since any circuit system has its own noise, the noise value needs to be subtracted during measuring a parameter so as to obtain a real value of the parameter.

During the implementation, as shown in FIGS. 1 and 2, the color parameter measurement device may further include a light-beam-in-fourth-color receiver 350. The beam-splitting assembly 100 is further configured to split the display light beam from the to-be-tested display panel A into a fourth testing light beam a4. The light-beam-in-fourth-color receiver 350 is configured to convert an optical signal of the fourth testing light beam a4 into an electric signal and output the electric signal. The processor 400 is further configured to determine a brightness value of the display light beam in accordance with the electric signal from the light-beam-in-fourth-color receiver 350, and adjust in real time the color parameter in accordance with the electric signal from the light-beam-in-fourth-color receiver 350. For example, a fourth color is white W.

During the implementation, as shown in FIGS. 1 and 2, the color parameter measurement device may further include a glass plate 240 arranged on an optical path between the light-beam-in-fourth-color receiver 350 and the beam-splitting assembly 100. The glass plate 240 may have a thickness same as each filter, so as to eliminate the difference in the optical paths between the light-beam-in-fourth-color receiver 350 and the other receivers.

During the implementation, as shown in FIGS. 1 and 2, the color parameter measurement device may further include a light-beam-in-fourth-color convergent lens 540 arranged on an optical path between the light-beam-in-fourth-color receiver 350 and the glass plate 240. The light-beam-in-fourth-color convergent lens 540 may converge light energy from the glass plate 240 at a point on the light-beam-in-fourth-color receiver 350, so as to enable the light-beam-in-fourth-color receiver 350 to receive the light beam in an energy concentration manner, thereby to improve a response speed of the light-beam-in-fourth-color receiver 350.

During the implementation, as shown in FIG. 1, when the beam-splitting assembly 100 is the optical fiber assembly 110, the color parameter measurement device may further include a fourth collimating lens 640 arranged on an optical path between the optical fiber assembly 110 and the glass plate 240. The fourth collimating lens 640 may collimate the fourth testing light beam a4 from the optical fiber assembly 110 toward the glass plate 240, so as to reduce any interference light beam on the optical path.

Based on a same inventive concept, the present disclosure further provides in some embodiments a color parameter measurement method using the above-mentioned color parameter measurement device. A principle of the method is similar to that of the above-mentioned color parameter measurement device, so the implementation of the method may refer to that of the color parameter measurement device and thus will not be particularly defined herein.

To be specific, as shown in FIG. 4, the color parameter measurement method may include: S401 of splitting, by the beam-splitting assembly, a display light beam from a to-be-tested display panel into at least a first testing light beam, a second testing light beam and a third testing light beam; S402 of allowing, by the light-beam-in-first-color filter, a light-beam-in-first-color component of the first testing light beam to be transmitted to the light-beam-in-first-color receiver, and converting, by the light-beam-in-first-color receiver, the light-beam-in-first-color component into an electric signal and outputting the electric signal; S403 of allowing, by the light-beam-in-second-color filter, a light-beam-in-second-color component of the second testing light beam to be transmitted to the light-beam-in-second-color receiver, and converting, by the light-beam-in-second-color receiver, the light-beam-in-second-color component into an electric signal and outputting the electric signal; S404 of allowing, by the light-beam-in-third-color filter, a light-beam-in-third-color component of the third testing light beam to be transmitted to the light-beam-in-third-color receiver, and converting, by the light-beam-in-third-color receiver, the light-beam-in-third-color component into an electric signal and outputting the electric signal; and S405 of determining, by the processor, a color parameter of the light-beam-in-first-color component in the display light beam in accordance with the electric signal from the light-beam-in-first-color receiver, determining a color parameter of the light-beam-in-second-color component in the display light beam in accordance with the electric signal from the light-beam-in-second-color receiver, and determining a color parameter of the light-beam-in-third-color component in the display light beam in accordance with the electric signal from the light-beam-in-third-color receiver.

During the implementation, the color parameter measurement method may further include: S501 of splitting, by the beam-splitting assembly, the display light beam from the to-be-tested display panel into a fourth testing light beam; S502 of converting, by the light-beam-in-fourth-color receiver, an optical signal of the fourth testing light beam into an electric signal and outputting the electric signal; and S503 of determining, by the processor, a brightness value of the display light beam in accordance with the electric signal from the light-beam-in-fourth-color receiver, and adjusting the color parameter in real time by the electric signal outputted from the light-beam-in-fourth-color receiver.

To be specific, S501 and S401 may be performed simultaneously, S402-S404 and S502 may be performed simultaneously, and S405 and S503 may be performed simultaneously.

According to the color parameter measurement device and the color parameter measurement method in the embodiments of the present disclosure, the display light beam from the to-be-tested display panel is split by the beam-splitting assembly into at least the testing light beams corresponding to the light-beam-in-first-color filter, the light-beam-in-second-color filter and the light-beam-in-third-color filter respectively. Next, the light-beam-in-first-color component, the light-beam-in-second-color component and the light-beam-in-third-color component of the corresponding testing light beams are transmitted to the corresponding receivers through the corresponding filters. Then, the light-beam-in-first-color component, the light-beam-in-second-color component and the light-beam-in-third-color component are converted into electric signals by the corresponding receivers, and then outputted to the processor for color parameter analysis, so as to rapidly calculate color characteristics of the to-be-tested display panel. As compared with the color parameter measurement using a beam-splitting spectrometer in the related art, through the color parameter measurement device in the embodiments of the present disclosure, it is able to shorten a measurement time period (e.g., reduce the measurement time period from 1-2 S to less than 50 ms), thereby to improve the production line efficiency.

In a possible embodiment of the present disclosure, a first color, a second color, a third color and a fourth color are red R, green G, blue B and white W respectively.

The above are merely the preferred embodiments of the present disclosure, but the present disclosure is not limited thereto. Obviously, a person skilled in the art may make further modifications and improvements without departing from the spirit of the present disclosure, and these modifications and improvements shall also fall within the scope of the present disclosure.

What is claimed is:

1. A color parameter measurement device, comprising a beam-splitting assembly, a light-beam-in-first-color filter, a light-beam-in-second-color filter, a light-beam-in-third-color filter, a light-beam-in-first-color receiver, a light-beam-in-second-color receiver, a light-beam-in-third-color receiver, and a processor, wherein
the beam-splitting assembly is configured to split a display light beam from a to-be-tested display panel into at least a first testing light beam, a second testing light beam and a third testing light beam;
the light-beam-in-first-color filter is configured to allow a light-beam-in-first-color component of the first testing light beam to be transmitted to the light-beam-in-first-color receiver;
the light-beam-in-first-color receiver is configured to convert the light-beam-in-first-color component into a first electric signal and output the first electric signal;
the light-beam-in-second-color filter is configured to allow a light-beam-in-second-color component of the second testing light beam to be transmitted to the light-beam-in-second-color receiver;
the light-beam-in-second-color receiver is configured to convert the light-beam-in-second-color component into a second electric signal and output the second electric signal;
the light-beam-in-third-color filter is configured to allow a light-beam-in-third-color component of the third testing light beam to be transmitted to the light-beam-in-third-color receiver;
the light-beam-in-third-color receiver is configured to convert the light-beam-in-third-color component into a third electric signal and output the third electric signal; and
the processor is configured to determine a color parameter of the light-beam-in-first-color component in the display light beam in accordance with the first electric signal from the light-beam-in-first-color receiver, determine a color parameter of the light-beam-in-second-color component in the display light beam in accordance with the second electric signal from the light-beam-in-second-color receiver, and determine a color parameter of the light-beam-in-third-color component in the display light beam in accordance with the third electric signal from the light-beam-in-third-color receiver.

2. The color parameter measurement device according to claim 1, further comprising a light-beam-in-first-color convergent lens arranged on an optical path between the light-beam-in-first-color receiver and the light-beam-in-first-color filter, a light-beam-in-second-color convergent lens arranged on an optical path between the light-beam-in-second-color receiver and the light-beam-in-second-color filter, and a light-beam-in-third-color convergent lens arranged on an optical path between the light-beam-in-third-color receiver and the light-beam-in-third-color filter.

3. The color parameter measurement device according to claim 1, wherein the beam-splitting assembly is an optical fiber assembly.

4. The color parameter measurement device according to claim 3, further comprising a first collimating lens arranged on an optical path between the optical fiber assembly and the light-beam-in-first-color filter, a second collimating lens arranged on an optical path between the optical fiber assembly and the light-beam-in-second-color filter, and a third collimating lens arranged on an optical path between the optical fiber assembly and the light-beam-in-third-color filter.

5. The color parameter measurement device according to claim 3, further comprising a first doublet and a second doublet arranged on an optical path between the optical fiber assembly and the to-be-tested display panel and opposite to each other, wherein a convex surface of the first doublet is arranged to face the to-be-tested display panel, and a convex surface of the second doublet is arranged to face the optical fiber assembly.

6. The color parameter measurement device according to claim 1, wherein the beam-splitting assembly comprises a beam splitter and a reflector.

7. The color parameter measurement device according to claim 1, wherein the beam-splitting assembly comprises a grating and a reflector.

8. The color parameter measurement device according to claim 1, wherein the beam-splitting assembly comprises a prism and a reflector.

9. The color parameter measurement device according to claim 6, further comprising a collimating lens assembly arranged on an optical path between the beam-splitting assembly and the to-be-tested display panel.

10. The color parameter measurement device according to claim 9, further comprising a third doublet and a fourth doublet arranged on an optical path between the collimating lens assembly and the to-be-tested display panel and opposite to each other, wherein a convex surface of the third doublet is arranged to face the to-be-tested display panel, and a convex surface of the fourth doublet is arranged to face the collimating lens assembly.

11. The color parameter measurement device according to claim 1, further comprising a dark state receiver arranged in a plane same as the light-beam-in-first-color receiver, the light-beam-in-second-color receiver and the light-beam-in-third-color receiver, and configured to convert an ambient light beam into an ambient light electric signal and output the ambient light electric signal, wherein the processor is further configured to determine a noise parameter of the ambient light beam in accordance with the ambient light electric signal from the dark state receiver.

12. The color parameter measurement device according to claim 1, further comprising a light-beam-in-fourth-color receiver, wherein
the beam-splitting assembly is further configured to split the display light beam from the to-be-tested display panel into a fourth testing light beam;
the light-beam-in-fourth-color receiver is configured to convert an optical signal of the fourth testing light beam into a fourth electric signal and output the fourth electric signal; and
the processor is further configured to determine a brightness value of the display light beam in accordance with the fourth electric signal from the light-beam-in-fourth-color receiver.

13. The color parameter measurement device according to claim 12, further comprising a glass plate arranged on an optical path between the light-beam-in-fourth-color receiver and the beam-splitting assembly.

14. The color parameter measurement device according to claim 13, further comprising a light-beam-in-fourth-color convergent lens arranged on an optical path between the light-beam-in-fourth-color receiver and the glass plate.

15. The color parameter measurement device according to claim 13, wherein the beam-splitting assembly is an optical fiber assembly, and the color parameter measurement device further comprises a fourth collimating lens arranged on an optical path between the optical fiber assembly and the glass plate.

16. The color parameter measurement device according to claim 1, wherein a first color, a second color and a third color are red, green and blue respectively.

17. The color parameter measurement device according to claim 12, wherein a fourth color is white.

18. A color parameter measurement method, comprising steps of:
splitting, by a beam-splitting assembly, a display light beam from a to-be-tested display panel into at least a first testing light beam, a second testing light beam and a third testing light beam;
allowing, by a light-beam-in-first-color filter, a light-beam-in-first-color component of the first testing light beam to be transmitted to a light-beam-in-first-color receiver, and converting, by the light-beam-in-first-color receiver, the light-beam-in-first-color component into a first electric signal and outputting the first electric signal;
allowing, by a light-beam-in-second-color filter, a light-beam-in-second-color component of the second testing light beam to be transmitted to a light-beam-in-second-color receiver, and converting, by the light-beam-in-second-color receiver, the light-beam-in-second-color component into a second electric signal and outputting the second electric signal;
allowing, by a light-beam-in-third-color filter, a light-beam-in-third-color component of the third testing light beam to be transmitted to a light-beam-in-third-color receiver, and converting, by the light-beam-in-third-color receiver, the light-beam-in-third-color component into a third electric signal and outputting the third electric signal; and
determining, by a processor, a color parameter of the light-beam-in-first-color component in the display light beam in accordance with the first electric signal from the light-beam-in-first-color receiver, determining a color parameter of the light-beam-in-second-color component in the display light beam in accordance with the second electric signal from the light-beam-in-second-color receiver, and determining a color parameter of the light-beam-in-third-color component in the display light beam in accordance with the third electric signal from the light-beam-in-third-color receiver.

19. The color parameter measurement method according to claim 18, further comprising:
splitting, by the beam-splitting assembly, the display light beam from the to-be-tested display panel into a fourth testing light beam;
converting, by a light-beam-in-fourth-color receiver, an optical signal of the fourth testing light beam into a fourth electric signal and outputting the fourth electric signal; and
determining, by the processor, a brightness value of the display light beam in accordance with the fourth electric signal from the light-beam-in-fourth-color receiver.

20. The color parameter measurement method according to claim 19, wherein a first color, a second color, a third color and a fourth color are red, green, blue and white respectively.
